(19) United States
(12) Patent Application Publication
(10) Pub. No.: US 2020/0084061 A1
(43) Pub. Date: Mar. 12, 2020

(54) SYSTEM FOR MONITORING AND CONTROLLING DEVICE ACTIVITY

(71) Applicant: Centrica PLC, Windsor (GB)

(72) Inventors: Matthew James Lawrenson, Lausanne (CH); Timothy Giles Beard, Lausanne (CH); Julian Charles Nolan, Lausanne (CH)

(73) Assignee: Centrica PLC, Windsor (GB)

(21) Appl. No.: 16/561,465

(22) Filed: Sep. 5, 2019

(30) Foreign Application Priority Data
Sep. 6, 2018 (GB) 1814551.6

(51) Int. Cl. H04L 12/28; H04N 21/442

(52) U.S. Cl. CPC H04L 12/282; H04L 2012/285; H04L 12/2827; H04N 21/44213

(57) ABSTRACT

A method for monitoring and controlling device activity is disclosed. The method comprises collecting device activity data relating to a first media consumer, wherein the device activity data corresponds to activity of one or more devices in an environment of the first media consumer during playback of a given media asset by the first media consumer. The method then determines, based on the device activity data, at least one action performable by a device in an environment of a second media consumer. Playback of the given media asset by the second media consumer is detected; and in response to detecting playback of the given media asset, one or more devices in an environment of the second media consumer are controlled to perform the determined actions.

### CROSS-REFERENCE TO RELATED APPLICATIONS

This application claims priority to United Kingdom Patent Application No. 1814551.6, entitled SYSTEM FOR MONITORING AND CONTROLLING DEVICE ACTIVITY, filed Sep. 6, 2018, which is incorporated herein by reference.

### BACKGROUND

The present invention relates to systems and methods for monitoring, predicting and controlling energy demand and device activity associated with consumption of media events.

Major media events can have a significant and predicable impact on home energy demands. People's energy use and behaviour are often synchronized during live events such as sports events, major news events or premieres of popular shows, and are therefore predictable to an extent. For example, live events can cause spikes in energy demand at certain points (e.g. at half-time in a football match).

However, entertainment is increasingly being consumed ‘on demand’, so while an individual's behaviour may be predictable relative to the media being played, each person may play the media at a different time-making energy demand predictions and optimizations harder to achieve.

On-demand media consumption has significantly changed the viewing of media at home (in March 2016 Netflix represented 35.2% of North American download fixed network bandwidth utilization). Individual shows or events can have big impacts. For example, in the US 12.1 million people watched the HBO show ‘Game of Thrones’ finale ‘live’, with 16.5 million watching it at some point during the night. The season averaged 30.6 million viewers.

Smart homes increasingly can be aware of activities in the home. Media recognition services like Shazam can use audio recordings to detect media being consumed. Voice assistants such as Amazon ‘Alexa’ are increasingly being used to control functions within the home including thermostats and lighting and can also control access to media services such as video and audio downloads.

### SUMMARY

In a first aspect of the invention, there is provided a method comprising: collecting device activity data relating to a first media consumer, wherein the device activity data corresponds to activity of one or more devices in an environment of the first media consumer during playback of a given media asset by the first media consumer; determining, based on the device activity data, at least one action performable by a device in an environment of a second media consumer; detecting playback of the given media asset by the second media consumer; and in response to detecting playback of the given media asset, controlling one or more devices in an environment of the second media consumer to perform the determined action(s).

The first and second consumer environments are preferably distinct environments and may be living or working environments (e.g. houses/apartments/offices or the like). In preferred embodiments the environments are respective smart homes, e.g. homes equipped with various network connected devices and/or sensors and/or comprising home automation/monitoring facilities. Media playback may be based on reception of broadcast or streaming media data assets, e.g. via Internet streaming or terrestrial/cable broadcast, or based on playback from local storage media.

Preferably, the method comprises collecting device activity data relating to a plurality of first media consumers, the device activity data corresponding to activity of devices in respective environments of the first media consumers, preferably during playback of the same given media asset. The plurality of first media consumers may comprise a predefined cohort of first media consumers, preferably comprising one of: a set of media consumers playing the media asset during a first broadcast of the media asset; and a set of media consumers playing the media asset during a predetermined time window, optionally a predetermined time window starting with the media asset first becoming available for playback by media consumers. The method may comprise determining an activity profile for the media asset based on the device activity data for the plurality of first media consumers, and wherein the determining step comprises determining the at least one action based on the activity profile.

The device activity data may indicate one or more of: activation, deactivation, and operational state of a device. Collecting device activity data may comprise receiving, from a device in the environment of a given media consumer, operational data (of said device), optionally indicating one or more of: activation, deactivation, and operational state of the device. Collecting device activity data may additionally or alternatively comprise receiving data from one or more sensors in the environment, and detecting activity of a device based on the sensor data, optionally wherein the one or more sensors comprise one or more of: an audio sensor or microphone, and an optical sensor or camera. The method may comprise analysing the sensor data to detect activity of a device, optionally by matching sensor data to predetermined signatures of device actions or device operating states. Such activity data may be collected for a plurality of distinct devices in the environment.

Preferably, the step of determining actions comprises determining for at least one action a time for the action relative to a start time of the media asset, the controlling step controlling a device to perform the action at the start time relative to start of playback of the media asset by the second media consumer. The least one action may comprise a schedule of a plurality of actions to be performed by one or more devices in the environment, each optionally associated with a time the action is to be performed.

The method may comprise selecting the one or more actions based on one or more of: a database of device actions available for given devices; and a database of media consumer data indicating controllable devices available in the media consumer's environment.

Preferably, the method comprises collecting device activity data relating to one or more first media consumers in response to detecting playback of the given media asset by the one or more first media consumers.

Detecting playback of the given media asset by a first media consumer (or any such first media consumer) or by a second media consumer (or any such second media consumer) may comprise one or more of: receiving playback data indicative of playback of the media asset from a media playback device used to play the media asset; receiving playback data indicative of playback of the media asset from a media streaming service providing the media asset to the media consumer; receiving sensor data from one or more sensors in the media consumer environment, the sensors optionally comprising an audio sensor or microphone for recording audio of the media asset during playback of the media asset. The method may comprise receiving audio data from an audio sensor and analysing the audio data to identify the media asset being played, and optionally further to identify a current playback location within the media asset, optionally by matching recorded audio data to audio data signatures in a database of media assets.

Preferably, controlling one or more devices in the environment comprises one or more of: activating a device; deactivating a device; setting an operating state of a device; and configuring a control setting, operating schedule or control program of a device. Controlling one or more devices may comprise controlling one or more lights, preferably to activate or deactivate said lights or set a brightness level or colour for said lights. Alternatively or additionally, controlling one or more devices may comprise controlling a temperature management system for managing a temperature of the environment, such as a heating or cooling system. The temperature management system may be controlled to activate, deactivate or set a target temperature level for the temperature management system or to alter a control schedule for the temperature management system.

The one or more devices may comprise one or more network-connected household appliances.

The method may comprise determining an activity profile for the media asset based on activity data for a plurality of first media consumers, and determining control actions for a plurality of second media consumers based on the activity profile. The second media consumers may comprise a second cohort of a plurality of second media consumers selected based on similarity to the first media consumers. The control actions are preferably further determined based on one or more of: predicted energy consumption data determined based on the activity profile; and service provider objectives of an energy provider providing energy to media consumer environments. Determining control actions for a plurality of second media consumers may comprise configuring control schedules for respective second media consumers so as to reduce or avoid peaks in energy demand.

Preferably, the (or each) first media consumer environment and/or the (or each) second media consumer environment comprises a smart home having a plurality of devices connectable to each other and/or to a smart home control system in the home and/or to an external network such as the Internet. Such environments may include a network for interconnecting devices and control systems and for connecting devices to an external network (e.g. the Internet).

Collecting device activity data may comprise collecting the device activity data using a smart home monitoring system installed at the first media consumer environment, and transmitting the device activity data to a central processing system over a network for storage and analysis.

The method may comprise performing the step of determining device actions at a central processing system based on device activity data received from one or more first media consumer environments; and transmitting the determined actions to one or more environments of one or more second media consumers, optionally to smart home control systems installed at the one or more second media consumer environments.

The controlling step may comprise transmitting control commands from a smart home control system, installed at the environment or connected remotely via a network, to the one or more devices in the second media consumer environment.

The invention further provides a computer-readable medium comprising software code adapted, when executed by one or more processors of a computer system, to perform any method as set out herein, and a system or computing device having means, preferably in the form of one or more processors with associated memory, for performing any method as set out herein.

Any feature in one aspect of the invention may be applied to other aspects of the invention, in any appropriate combination. In particular, method aspects may be applied to apparatus and computer program aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:

### BRIEF DESCRIPTION OF THE DRAWINGS

FIG. 1 illustrates a media-based demand prediction and control system in overview;

FIG. 2 illustrates a process for predicting behaviour and device activity for consumers of a media event and generating control schedules;

FIG. 3 illustrates a process for creating a media event profile;

FIG. 4 illustrates a process for creating and implementing a smart home schedule; and

FIG. 5 illustrates components of a prediction and control system.

### DETAILED DESCRIPTION

### Overview

Embodiments of the invention use smart home features and predictive modelling to provide predictions of device usage and energy demand in relation to media events, thus enabling energy optimisations at the individual home and at the aggregate level, as well as enhanced user experiences while consuming media events within the home.

In one example, the energy usage of a large set of media consumers is optimised in aggregate, via the design of a set of energy and smart home optimizations based on predicted contributions of individual users consuming media—where those predictions are based on training data provided by a ‘first cohort’ (smaller) set of consumers of the specific media, their emotions and reactions to the media, and socio-demographic data on the users.

Embodiments of the invention provide some or all of the following functions:

Predicting an individual's behaviour, in particular device usage and home energy consumption, while consuming particular media content.

Optimising the home environment/energy usage of a set of media consumers based on knowledge about the consumers and the media they are consuming.

Predicting and managing aggregated energy demand by determining its relationship to home media consumption.

In overview, embodiments of the invention may implement the following process:

1. The system creates a set of profiles for a set of media consumers in relation to their consumption of media at home.

2. The system evaluates the behaviour of a small set of people who consume a media event live, grouping people in this set according to characteristics that may differentiate their behaviours during the media event, for example the team they support for a sporting event.

3. The system then uses this information from the initial set of consumers to predict the behaviour of a larger set of people when they consume the same media in the future via on-demand services, based on a similarity assessment between members of the larger set and members of the initial smaller set.

4. The system then implements steps to enhance the media experience and optimise energy usage for this set of people based on their predicted behaviour with regards to the consumption of the media event.

5. The system may additionally implement steps to optimise the aggregated media-related energy demand with regard to the goals of the energy service provider.

To achieve the above functions, embodiments may provide some or all of the following features:

A system to track the media consumption activities, responses (e.g. emotions) and device usage of a first set of users during a specific media event (e.g. a sporting event or TV show) who are viewing the event “live” or soon after the media is made available.

An algorithm to predict the user activities and responses of a large group of media consumers based on the activities of a smaller initial set of media consumers and an estimation of similarity of users in the large group to users in the small group.

A system to design and deploy a set of energy and smart home optimizations for a following set of users consuming a specific media event at a later time e.g. via a streaming service, based on information about energy use/device usage gathered from the first cohort of users and other earlier consumers of the media.

An algorithm to optimise the aggregated energy demand profile of an energy service provider in relation to the consumption of media within the homes supplied by the service provider.

### Detailed Description Of An Embodiment

In the present description, the term “Smart Home” preferably indicates a home containing technologies (especially network-connected devices, appliances etc.) that enhance the experience of residing in the home, including (for example) automated heating and lighting control, voice assistants, sensors, monitoring services etc.

A “Media Event” is considered to be any media event or asset that is “consumed” (e.g. watched, listened to) inside a Smart Home, delivered via live broadcast or on demand via streaming services to Smart Home consumption devices such as a screen or speakers. Media Events include, but are not limited to, sporting events, news events, films, and TV shows.

A Media Event typically comprises a media asset (for example, an audio/video file, stream or other media data object, or collection of files/streams/objects) that is played back by a consumer using a suitable media playback device (e.g. a network streamer, network-connected Blu-Ray/DVD/CD disc player, smart TV etc.) While playback of media assets may typically occur via network streaming (e.g. over the Internet or from a media server in the smart home) or broadcast (e.g. via cable network or over-the-air TV broadcast), the system may also be applied to local media playback from a media carrier or storage device (e.g. disc).

A “Media Consumer” may be any consumer of a Media Event within a Smart Home. A Media Consumer is thus typically a user of a media playback device in the Smart Home and may more generally also be considered a user of the wider system described herein. In relation to a Media Event, Media Consumers can belong to:

a “First Cohort”—a set of Media Consumers who are early consumers of a Media Event. This includes watching the event “live” or during its first broadcast.

a “Following Cohort”—a set of Media Consumers, expected to be much larger than the First Cohort, who consume a Media Event later than the First Cohort, at a time of their own choosing via on-demand services, or during a repeat broadcast.

The term “Media Player” preferably refers to a device that delivers a Media Event to a Media Consumer either live or on-demand at a future time, for example a television with streaming capabilities, a radio, smart speaker, tablet or smartphone.

An “Energy Service Provider” is typically an owner/operator of the system described herein. They are responsible for managing the infrastructure required for the system and commonly also for the provision and management of energy to the Smart Homes. The Energy Service Provider may have a set of objectives in terms of energy demand management (“Service Provider Objectives”). These may include, for example, peak demand management, load balancing etc.

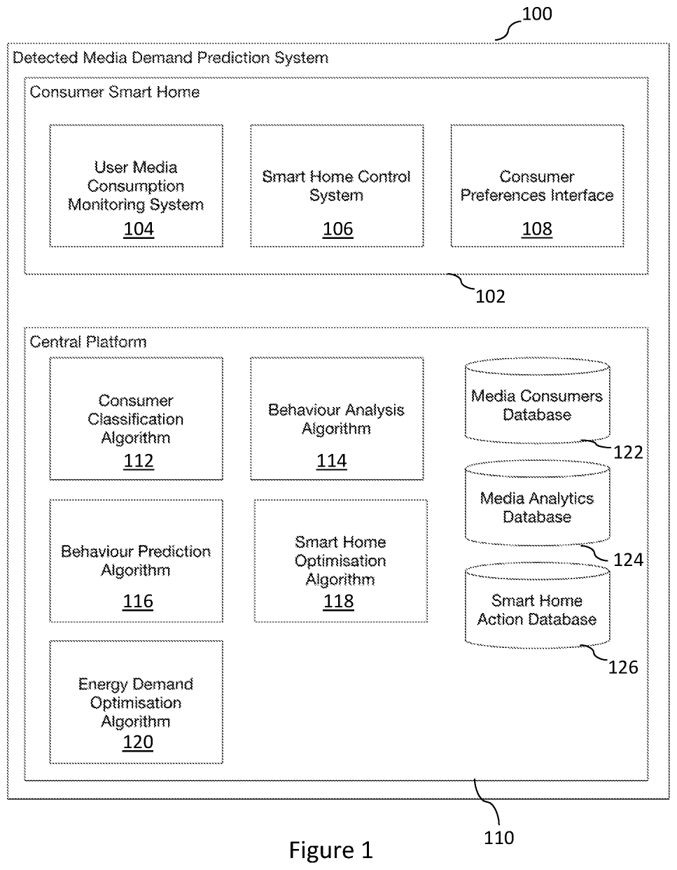

FIG. 1 illustrates key components of a demand prediction system 100 in overview. The main elements of the system are the Consumer Smart Home System 102 and a Central Platform 110.

The Consumer Smart Home System 102 comprises a User Media Consumption Monitoring System 104, which includes a set of devices that enable Media Consumers and the consumption of Media Events to be monitored in a Smart Home. This may include:

Direct logging of Media Events delivered to a Smart Home (e.g. by interfacing with a media player device, media streaming service, by data traffic inspection etc.)

Listening devices and a system to predict/detect what Media Events are being consumed.

Visual or other means of observing the actions and emotions of Media Consumers including their concurrent use of smart devices in addition to those used to consume the Media Event.

A system to monitor the use of appliances within a Smart Home

Also provided within the smart home is a Smart Home Control System 106. This enables the monitoring and control of appliances and environmental conditions within the home, including for example lighting, heating/cooling, dishwasher, washing machine fridges/freezers etc.

Additionally, a Consumer Preferences Interface 108 may be provided which enables Media Consumers within the Smart Home to indicate preferences with regard to monitoring and actions that the Consumer Smart Home System may perform. This may be in the form of an app on a smart device, a standalone interface or a voice activated system.

The Central Platform 110 comprises a collection of algorithms/computer processes and associated databases, and is typically implemented by way of one or more servers installed remotely from the smart home(s) and connected to the smart home systems 102 via the Internet and/or other networks.

In particular, the Central Platform 110 may comprise the following databases:

A Media Consumers Database 122, which is a database containing information on the Media Consumers.

A Media Analytics Database 124 containing profiles for individual Media Events (“Behaviour Profiles”). The Behaviour Profiles include information on Media Consumer actions, device actions and user responses/emotions during the Media Event, synchronised to points during the Media Event at which the actions or responses occur. This information is gathered from the User Media Consumption Monitoring Systems 104 within users' Smart Homes. Additionally, data that may affect behaviours such as time of day, day of the week, weather etc. may be gathered and stored in the Media Analytics Database (or a separate database).

A Smart Home Action Database 126 containing information on actions that may be performed within a Smart Home (“Smart Home Actions”), their impact on energy consumption and their predicted impact on Media Consumers with regard to their consumption of Media events. The database may specify actions available for different specific types (e.g. makes/models/classes) of devices, and/or may specify actions available in specific Smart Homes.

The Central Platform 110 may additionally implement the following algorithms, which utilise the data stored in the various databases.

A Consumer Classification Algorithm 112 takes as input information about Media Consumers from the Media Consumer Database and generates classifications of the Media Consumers (“Consumer Classifications”) with regards to types of Media Event.

A Behaviour Analysis Algorithm 114 takes as input the data from the observation of Media Consumers by the User Media Consumption Monitoring System 104 while they consume Media Events, and generates Behaviour Profiles.

A Behaviour Prediction Algorithm 116 uses Behaviour Profiles from First Cohort consumers of a Media Event, plus information from the Media Consumers Database to generate predicted Behaviour Profiles for members of the following Cohort (“Predicted Behaviour Profiles”).

A Smart Home Optimisation Algorithm 118 takes as input a Following Cohort Media Consumer's Predicted Behaviour Profile during a Media Event and Smart Home Actions, and generates a schedule of Smart Home Actions and optimisations (“Smart Home Schedule”) for that Media Consumer to perform when they consume that Media Event.

An Energy Demand Optimisation Algorithm 120 takes as input the Behaviour Profiles, Predicted Behaviour Profiles and Smart Home Schedules, and outputs Smart Home Schedules adjusted to achieve Service Provider Objectives.

### Demand Prediction, Smart Home Control and Optimisation Process

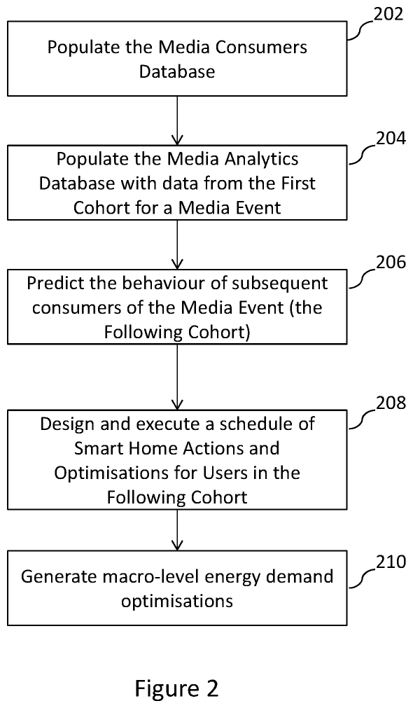

FIG. 2 illustrates a process for performing home energy optimisations and macro level energy demand predictions for a large set of media consumers based on the behaviour of a smaller set of initial media consumers.

In step 202, the Media Consumers Database is populated. This involves gathering data related to Media Consumers and storing this in the Media Consumers Database. This may include:

Demographic data, such as age, gender, income etc.

Media preferences

Viewing habits (e.g. binge watchers, late night viewers, eat-while-watching etc.)

Other preferences or personal information relating to media consumption, such as sporting allegiances

Social media data

The data gathering stage may involve classifying Media Consumers according to categories that are likely to affect their behaviour and energy consumption patterns. For example, classifications may include “Binge watcher”, “Live eventer”, “Eat while watching”, “Dual screen user” as well as sporting allegiances, media preferences, likelihood of consuming particular Media Events etc. Data for classification may come from a variety of sources including direct observation, Smart Home activities, streaming video consumption history, social media profiles etc.

In an embodiment, the Media Consumers Database may additionally store information on the smart home configurations of particular Media Consumers. For example, each consumer may be associated with a profile specifying the set of controllable smart home devices in that consumer's smart home.

In step 204, the Media Analytics Database is populated with data from the First Cohort for a Media Event.

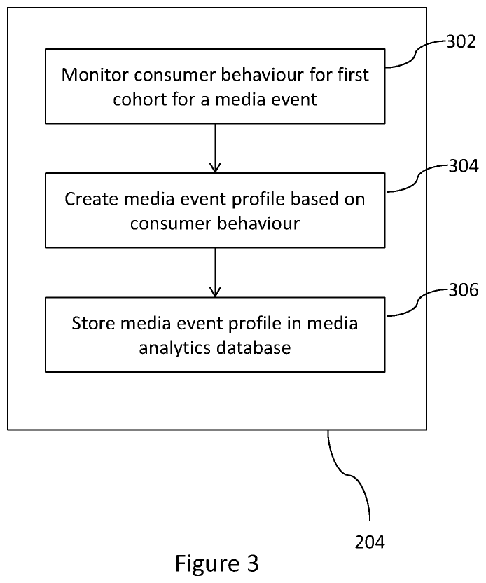

This step is illustrated further in FIG. 3. In step 302, for each Media Event, the system monitors Media Consumer behaviour, device activity and responses (e.g. emotions) during first-time showing of the Media Event.

Thus, the Media Consumers viewing the Media Event at this time form the “First Cohort” for the Media Event. Note that the first-time showing may correspond e.g., to an initial live broadcast/stream of the event, or to on-demand streaming within a predetermined time window of the Media Event becoming available for streaming (e.g. within the first 12 hours). Alternatively, the First Cohort and hence first-time showing may be defined as the first N users to consume a particular media event through on-demand streaming or the like, or may be determined in some other way.

Methods for monitoring the behaviour of the First Cohort of consumers of the Media Event may include:

Monitoring device activity for smart home devices in the consumer's home

Monitoring Smart Home energy usage, e.g. obtaining energy consumption data from a connected smart energy meter.

Obtaining Information directly from the media provision service

Monitoring social media activity of the Media Consumers, e.g. Twitter activity related to the Media Event

A key aspect of the activity monitoring is the detection and monitoring of device activity for smart home devices in the consumer's home. Detected device activity may include device activation (turning on), device deactivation (turning off) and/or different operating states or modes of devices. The detection capabilities may depend on the type of device. For example, for an ordinary light, the system may detect a light being turned on or off, but for a dimmable light may additionally detect a brightness level set for the light. For an appliance such as a washer/drier the system may detect turn-on/turn-off and additionally may detect different operating states such a wash cycle, spin cycle, and drying operation.

Device activity detection preferably occurs by direct monitoring use of smart devices such as smart lights, connected appliances, HVAC (heating/ventilation/air-conditioning) systems, conventional devices controlled by smart plugs etc. This involves obtaining data specifying operational state directly from a device over the network or from a smart home control system controlling the device (e.g. via a suitable smart home control API).

In some cases (e.g. for non-connected devices which cannot provide operating state information electronically), device activity detection is performed indirectly, by use of Smart Home devices such as cameras, microphones or other sensors to detect user actions and device activity. For example, audio data acquired from a microphone (e.g. in a smart speaker) can be analysed to detect specific audio signatures associated with activation or deactivation of a device or different operating states of a device (e.g. a washing machine spin cycle). In a similar manner, cameras may be used to detect lights being turned on/off or other visual indicators of device activity, using image processing techniques. The system may store sensor data signatures for different operating states or state transitions (e.g. activation/deactivations) of a range of devices and compare acquired sensor data (e.g. audio/video data from microphones/cameras) to stored signatures to detect (upon signature match) a specific device and/or a specific operating state or state transition of the device.

In step 304, the system builds up the Behaviour Profile for each Media Consumer in relation to the Media Event. In a preferred embodiment, this profile provides a record of Media Consumer actions and smart home device activity logged with timing information, e.g. indicating time of events with respect to media event start time (thus the profile may effectively be synchronized to a timeline of the media event).

Observed behaviour recorded in the profile includes device activity as described above, and may additionally include use of a second screen (e.g. smartphone), consumption of food and drink, emotional responses etc. Such additional behaviour information may be detected e.g. through image analysis of video camera feeds or the like. Optionally, environmental factors such as time of day, day of the week and weather can be taken into account. Similar users not consuming the Media Event can be monitored to establish a baseline which can be subtracted from the Media Consumers behaviour to establish the components of behaviour that are likely due to the Media Event.

In step 306, the compiled data is stored as Behaviour Profiles for the Media Event in the Media Analytics Database. The data may be anonymised in such a way that individual users cannot be identified from their actions and emotions data, but the data goes towards building anonymous categorised profiles.

Returning to FIG. 2, in step 206, the behaviour of subsequent Media Consumers of the Media Event, i.e. the Following Cohort, is predicted.

The Behaviour Prediction Algorithm takes the Behaviour Profiles of the First Cohort data and Following Cohort Consumer Classifications and, using similarity matching based on the Consumer Classifications and existing Behaviour Profiles, outputs a Predicted Behaviour Profile for Media Consumers of the Media Event in the Following Cohort.

In one approach, prediction may be based on analysing the collected activity data for the First Cohort consumers and summarising the activity/behaviour data by detecting patterns or commonalities across the different users of the First Cohort. For example, corresponding or similar device activities or other behaviours detected for multiple (possibly a majority) of users of the First Cohort may be added to the Predicted Behaviour Profile, whilst rare or singular detected activities or behaviours may be ignored. Timing information may be taken into consideration; for example, if a corresponding or similar device activity (e.g. dimming lights) is detected for multiple consumers in the First Cohort at a similar time (e.g. within a given window) relative to start of the media event, the activity may be recorded in the Predicted Behaviour Profile for the media event with appropriate time information (e.g. specifying an averaged time value or time window corresponding to the detected times for the different consumers). In this way, the Predicted Behaviour Profile may provide an indication of predicted device activity (activations, deactivations, operating state changes etc.), possibly with associated timing information relative to the start of the Media Event.

Predicted device activities specified in a Predicted Behaviour Profile may then additionally be used to calculate energy consumption predictions for subsequent consumers of the Media Event.

As subsequent Media Consumers experience the Media Event, their behaviour may optionally be analysed to generate Behaviour Profiles and update the Media Analytics Database in order to improve predictions for future consumers of that Media Event.

In step 208, the system designs and executes a schedule of Smart Home actions and optimisations for Users in the Following Cohort.

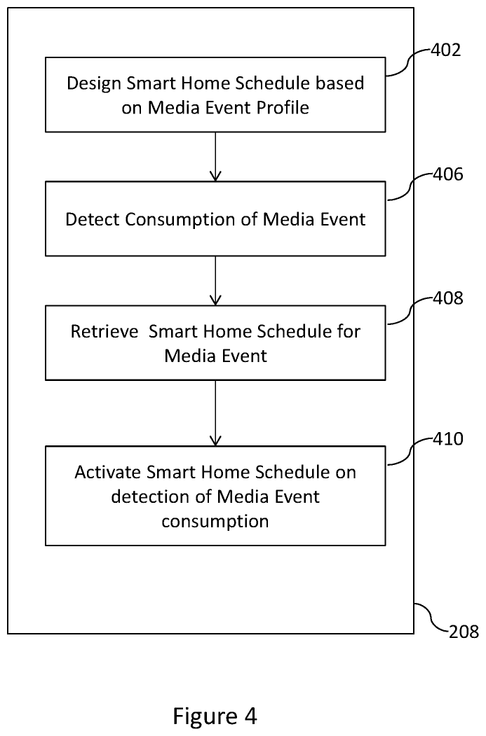

This step is illustrated in greater detail in FIG. 4. As shown there, in step 402, the Smart Home Optimisation Algorithm uses Predicted Behaviour Profiles from the Behaviour Prediction Algorithm plus data from the Smart Home Actions database to design the Smart Home Schedule to perform when members of the Following Cohort consume the Media Event.

Actions and optimisations may include, for example, altering heating/cooling or appliance use in areas based on whether they are or are not expected to be used during the consumption of the Media Event.

The actions and optimisations may include proactive changes, including but not limited to:

Dimming lights and/or setting “do not disturb” mode during known exciting sections.

Controlling noisy appliances such as refrigerator pumps and washing machines to prevent disturbances based on knowledge of the Media Event, e.g. stopping use during quiet parts of the media, or allowing them to be in use during noisy or highly engaging sections to take advantage of inattentional deafness.

Preheating the bed or bedroom shortly before the user is predicted to finish watching for the evening.

The actions may include actions corresponding to the predicted activity in the Predicted Behaviour Profile (e.g. if the prediction based on the activity of the First Cohort is a light dimming action, a corresponding light dimming action can be implemented in the Smart Home Schedule for the Following Cohort). However, the actions may also include actions different from those performed by the First Cohort consumers, e.g. to address some expected need or requirement based on the observed behaviour of the First Cohort consumers and/or based on predicted behaviour of the Following Cohort consumers.

In step 406, the consumption of a Media Event in a Smart Home is identified. Identification of the Media Event, and optionally also the playback location within that Media Event (e.g. time index relative to start of the Media Event) may be achieved via Smart Home devices such as smart home assistants (e.g. smart speakers) that can listen to ongoing activities and identify specific media using media recognition services. Typically, this is based on capturing audio using a microphone in a relevant device, and comparing/matching the audio to signatures of media assets in a database of media assets, such as films, TV program episodes, songs, audiobooks and the like. Personal devices with microphones such as mobile smartphones, tablet and personal computers may also be used to perform detection.

Alternatively, the Media Event details may be made available to the system directly from the Media Player. For example, a Smart Home connected media playback device (e.g. streamer, Blu-Ray player, smart TV etc.) may report media playback actions directly to the Smart Home Control System 106, allowing actions such as starting and stopping of playback to be detected directly by User Media Consumption Monitoring System 104. In an alternative approach, the media playback information may be obtained from a streaming platform (e.g. a video-on-demand server).

Note that the above techniques for detecting playback of a Media Event by a user in the Second Cohort may also be used during the initial monitoring of First Cohort consumers, to detect the original playback of the media event and trigger data collection (in step 204 of FIG. 2).

Once the playback of the Media Event has been detected in step 406, the Smart Home Schedule is retrieved from the Central Platform 110 in step 408. Alternatively, the Smart Home Schedule may have been transmitted to the Smart Home Control System 106 at an earlier time, prior to detection of the Media Event, so as to be available immediately when the Media Event is detected. In such an embodiment, the Smart Home Control System may comprise a database of Smart Home Control Schedules/Actions, each linked to a specific Media Event. On detection of a Media Event, the relevant schedule/action is then retrieved immediately from the local database.

In step 410, the Smart Home Schedule is activated. This involves invoking actions within the Smart Home by the Smart Home Control System, for example:

Turning lights on or off or adjusting brightness or colour/hue of lights;

Activating/deactivating/adjusting heating, air conditioning, fans etc., e.g. by adjusting a target temperature for a heating system

Controlling connected appliances (e.g. washing machines, dishwashers etc.), for example to turn on/off/change operating mode or change a configured control setting or program (e.g. wash program of a washing machine), e.g. to suppress noise

As another example, control may involve configuring or altering an operating schedule of a programmable device, e.g. a heating schedule for a smart thermostat controlled heating system.

Control is effected by transmitting control commands to relevant devices over the network in the smart home.

Control may extend to other devices, such as user's personal devices (smartphones, tablet/personal computers etc.) For example, a control action could involve switching a user's smartphone or other device onto silent mode or do-not-disturb mode at the start of the Media Event and possibly reversing that setting at the end of the Media Event.

Control actions in the Smart Home Schedule may be carried out immediately (i.e. as soon as the Media Event is detected and the Smart Home Schedule is activated), or at specific points in time. Actions in the Schedule may be associated with specific times (e.g. relative to the start of the Media Event), with those actions then triggered at the appropriate time.

Smart Home Schedules may be generic (for multiple users) or tailored to specific users. For example, during retrieval of the Smart Home Schedule (step 408), or at the point of activation (step 410), control actions in the Smart Home Schedule that are not compatible with a particular Smart Home, may be deleted from the Schedule (e.g. lighting control actions in a Smart Home that does not have controllable lights). Alternatively, tailored schedules may initially be generated for different Smart Homes (step 402), so that a given Smart Home Control System always receives and applies a schedule appropriate to that Smart Home. This may be based on smart home configuration data stored in the Media Consumers Database 122 (e.g. specifying available controllable devices in a particular consumer's Smart Home.)

Returning to FIG. 2, in step 210, the system may additionally generate macro-level energy demand optimisations.

To do this, the system uses the Energy Demand Optimisation Algorithm 120 (FIG. 1) to aggregate the predicted behaviour and scheduled actions for the users in the Following Cohort, and provide a macro-level energy demand profile.

Adjustments to Smart Home Schedules can be made in order to optimise the aggregated energy use profile in regard to the Service Provider Objectives where these adjustments are predicted to have minimal impact on individual Media Consumers due to their media consumption activities. Adjustments may e.g. serve to reduce or avoid peaks in energy demand. Adjustments may include:

Adjustments to the timing of Smart Home Actions, e.g. scheduled heating is delayed in order to reduce a predicted peak in demand.

Adjustments to the type of Smart Home Actions

Adjustments may be made on the basis of predicted energy consumption data derived from Predicted Behaviour Profiles.

Optionally, methods to influence Media Consumer Behaviour may be used in order to increase the achievement of Service Provider Objectives. This may include sending messages to Media Consumers, e.g. via smart devices in the home, that are designed to adjust the time they consume a Media Event, or the Media Event they consume. Messages may also include reminders, adverts or offers based on information from the Media Consumer Database.

### System Architecture

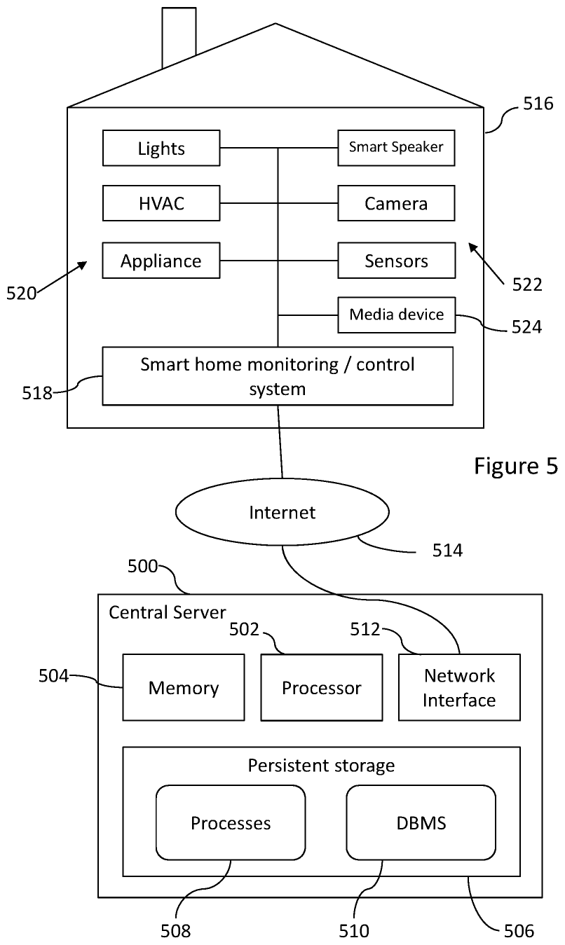

An example computer system for implementing described techniques is illustrated in FIG. 5. The system includes a server 500 for implementing functions of the Central Platform 110 as depicted in FIG. 1. The server includes one or more processors 502 together with volatile/random access memory 504 for storing temporary data and software code being executed.

Persistent storage 506 (e.g. in the form of hard disk storage, optical storage and the like) persistently stores software for performing various described functions, including a set of demand analysis, prediction and control processes 508 (e.g. comprising the various algorithms 112-120 as shown in FIG. 1), and a database management system 510 for storing data used by the processes, including for example databases 122-126 as shown in FIG. 1. The persistent storage also includes other server software and data (not shown), such as a server operating system.

The server will typically include other conventional hardware and software components as known to those skilled in the art.

A network interface 512 is provided for communication with other system components and in particular with a large number of Smart Homes including Smart Home 516 over a wide area network (typically comprising the Internet) 514. The Smart Home 516 includes a smart home monitoring and control system 518 (e.g. a local computing node or hub), which comprises software implementing subsystems 104-108 as depicted in FIG. 1.

The smart home monitoring/control system 518 is connected to a variety of smart devices throughout the smart home via a local network (e.g. including one or more wired and/or wireless networks). These are broadly divided into controllable devices 520 and sensor devices 522. Controllable devices 520 may, for example, include lighting, heating/ventilation/air-conditioning (HVAC) systems, smart appliances (e.g. washing machines, dryers, dishwashers) etc. Sensor devices may include smart speakers (or other devices with microphones), cameras, and other sensors (e.g. temperature sensors). Note that the specific set of devices shown in FIG. 5 is purely by way of example and the division into controllable devices and sensor devices is conceptual since some devices (e.g. a smart speaker) may function both as sensor (e.g. recording sound) and as controllable device (e.g. playing back media). Media devices 524 (e.g. media streamers, smart TVs etc.) provide playback of the Media Events; if these are directly connected to the monitoring/control system 518 then media playback may be detected directly or alternatively media playback may be detected indirectly using sensors as described previously.

The smart home monitoring/control system 518 records data about the smart home, including detected media event playback and device activity, based on information from the devices directly or from sensor devices 522 and transmits relevant data to the central server 500. The central server performs analysis functions as described previously and generates Smart Home Schedules for transmission back to the Smart Home. The Smart home monitoring/control system then executes the Smart Home Schedule by controlling controllable devices 520 in accordance with the Schedule.

While a specific architecture is shown by way of example, any appropriate hardware/software architecture may be employed.

Functional components indicated as separate may be combined and vice versa. For example, the functions of server 500 may in practice be implemented by multiple separate server devices, e.g. by a cluster of servers. For example, the processes 508 and DBMS 510 may be hosted on different server devices. Also, the various functions may be divided between the smart home monitoring/control system 518 in the Smart Home and the central server 500 in any appropriate manner. In one example, all processing could be performed centrally, at server 500, with the various Smart Home devices directly connected to the Internet, removing the need for a separate computing node in the Smart Home.

Embodiments described above may provide a number of advantages, for example:

The optimisation of a smart home's energy use with regard to the consumption of media within the home.

Improvements to the aggregated demand management capabilities of an energy service provider.

An enhanced and personalised user experience correlated to the consumption of media within a smart home.

It will be understood that the present invention has been described above purely by way of example, and modification of detail can be made within the scope of the invention.

What is claimed is:

1. A method comprising:
collecting device activity data relating to a first media consumer, wherein the device activity data corresponds to activity of one or more devices in an environment of the first media consumer during playback of a given media asset by the first media consumer;
determining, based on the device activity data, at least one action performable by a device in an environment of a second media consumer;
detecting playback of the given media asset by the second media consumer; and
in response to detecting playback of the given media asset, controlling one or more devices in an environment of the second media consumer to perform the determined action(s).

2. A method according to claim 1, comprising collecting device activity data relating to a plurality of first media consumers, the device activity data corresponding to activity of devices in respective environments of the first media consumers.

3. A method according to claim 2, wherein the plurality of first media consumers comprises a predefined cohort of first media consumers preferably comprising one of:
a set of media consumers playing the media asset during a first broadcast of the media asset;
a set of media consumers playing the media asset during a predetermined time window, optionally a predetermined time window starting with the media asset first becoming available for playback by media consumers.

4. A method according to claim 2, comprising determining an activity profile for the media asset based on the device activity data for the plurality of first media consumers, and wherein the determining step comprises determining the at least one action based on the activity profile.

5. A method according to claim 1, wherein the device activity data indicates one or more of: activation, deactivation, and operational state of a device.

6. A method according to claim 1, wherein collecting device activity data comprises receiving, from a device in the environment of a given media consumer, operational data, optionally indicating one or more of: activation, deactivation, and operational state of the device.

7. A method according to claim 1, wherein collecting device activity data comprises receiving data from one or more sensors in the environment, and detecting activity of a device based on the sensor data, optionally wherein the one or more sensors comprise one or more of: an audio sensor or microphone, and an optical sensor or camera; the method comprising analysing the sensor data to detect activity of a device, optionally by matching sensor data to predetermined signatures of device actions or device operating states.

8. A method according to claim 1, wherein determining actions comprises determining for at least one action a time for the action relative to a start time of the media asset, the controlling step controlling a device to perform the action at the start time relative to start of playback of the media asset by the second media consumer.

9. A method according to claim 1, wherein the at least one action comprises a schedule of a plurality of actions to be performed by one or more devices in the environment, each optionally associated with a time the action is to be performed.

10. A method according to claim 1, comprising selecting the one or more actions based on one or more of:
a database of device actions available for given devices; and
a database of media consumer data indicating controllable devices available in the media consumer's environment.

11. A method according to claim 1, comprising collecting device activity data relating to one or more first media consumers in response to detecting playback of the given media asset by the one or more first media consumers.

12. A method according to claim 1, wherein detecting playback of the given media asset by a first media consumer or by a second media consumer comprises one or more of:
receiving playback data indicative of playback of the media asset from a media playback device used to play the media asset;
receiving playback data indicative of playback of the media asset from a media streaming service providing the media asset to the media consumer;
receiving sensor data from one or more sensors in the media consumer environment; wherein the sensors optionally comprise an audio sensor or microphone for recording audio of the media asset during playback of the media asset, the method comprising receiving audio data from the audio sensor and analysing the audio data to identify the media asset being played, and optionally further to identify a current playback location within the media asset.

13. A method according to claim 1, wherein controlling one or more devices in the environment comprises one or more of:
activating a device;
deactivating a device;
setting an operating state of a device;
configuring a control setting, operating schedule or control program of a device.

14. A method according to claim 1, wherein controlling one or more devices comprises one or more of:
controlling one or more lights, preferably to activate or deactivate said lights or set a brightness level or colour for said lights;
controlling a temperature management system for managing a temperature of the environment, such as a heating or cooling system;
controlling a temperature management system to activate, deactivate or set a target temperature level for the temperature management system or to alter a control schedule for the temperature management system.

15. A method according to claim 1, wherein the one or more devices comprise one or more network-connected household appliances.

16. A method according to claim 1, comprising determining an activity profile for the media asset based on activity data for a plurality of first media consumers, and determining control actions for a plurality of second media consumers based on the activity profile, wherein determining the control actions optionally comprises one or more of:
configuring control schedules for respective second media consumers so as to reduce or avoid peaks in energy demand; and
determining the control actions based on one or more of:
predicted energy consumption data determined based on the activity profile; and
service provider objectives of an energy provider providing energy to media consumer environments.

17. A method according to claim 1, wherein the (or each) first media consumer environment and/or the (or each) second media consumer environment comprises a smart home having a plurality of devices connectable to each other and/or to a smart home control system in the home and/or to an external network such as the Internet;
wherein collecting device activity data comprises collecting the device activity data using a smart home monitoring system installed at the first media consumer environment, and transmitting the device activity data to a central processing system over the external network for storage and analysis.

18. A method according to claim 1, comprising performing the step of determining device actions at a central processing system based on device activity data received from one or more first media consumer environments; and transmitting the determined actions to one or more environments of one or more second media consumers, optionally to smart home control systems installed at the one or more second media consumer environments.

19. A method according to claim 1, wherein the controlling step comprises transmitting control commands from a smart home control system, installed at the environment or connected remotely via a network, to the one or more devices in the second media consumer environment.

20. A tangible computer-readable medium comprising software code adapted, when executed by one or more processors of a computer system, to perform the steps of:
collecting device activity data relating to a first media consumer, wherein the device activity data corresponds to activity of one or more devices in an environment of the first media consumer during playback of a given media asset by the first media consumer;
determining, based on the device activity data, at least one action performable by a device in an environment of a second media consumer;
detecting playback of the given media asset by the second media consumer; and
in response to detecting playback of the given media asset, controlling one or more devices in an environment of the second media consumer to perform the determined action(s).

21. A system comprising one or more processors with associated memory configured to:
collect device activity data relating to a first media consumer, wherein the device activity data corresponds to activity of one or more devices in an environment of the first media consumer during playback of a given media asset by the first media consumer;
determine, based on the device activity data, at least one action performable by a device in an environment of a second media consumer;
detect playback of the given media asset by the second media consumer; and
in response to detecting playback of the given media asset, control one or more devices in an environment of the second media consumer to perform the determined action(s).
